(19) United States
(12) Patent Application Publication
(10) Pub. No.: US 2025/0388043 A1
(43) Pub. Date: Dec. 25, 2025

(54) Mixing and Storage Tray for Paints and Hand-Mixed Products

(71) Applicant: Ian D. Orr, Cortlandt, NY (US)

(72) Inventor: Ian D. Orr, Cortlandt, NY (US)

(21) Appl. No.: 18/751,198

(22) Filed: Jun. 22, 2024

(51) Int. Cl. B44D 3/12; B44D 3/14

(52) U.S. Cl. CPC B44D 3/128; B44D 3/125; B44D 3/14

(57) ABSTRACT

The proposed invention relates to mixing and storage tray for paints and hand-mixed products is a multifunctional solution designed to streamline painting and hand-mixing activities. this innovative tray provides a convenient platform for mixing paints, storing brushes, and holding paint cans without the risk of leaks or spills, thanks to its waterproof design. It features specialized compartments for organizing a mixing bowl, slime ingredients, and utensils, making it ideal for slime-making enthusiasts as well. This tray enhances efficiency and cleanliness in workspaces by effectively containing liquids such as spilled paint or water for brush soaking. Whether used by professionals or hobbyists, this versatile tray offers a practical and organized approach to managing painting and hand-mixing tasks, improving productivity and eliminating messy cleanup.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a mixing and storage tray designed for the convenience of painters, artists, and hobbyists who frequently use paints and hand-mixed products such as slime. It caters to the need for a versatile and efficient solution to mix, store, and contain various materials during and after use. With its compartments and waterproof design, the tray is suitable for mixing paint, storing brushes, and holding paint cans while preventing leaks and spills. Additionally, it facilitates the mixing and storage of slime, providing designated areas for a mixing bowl, slime ingredients, and utensils, thus it offers a practical and organized approach to managing painting and hand-mixing activities, enhancing efficiency and cleanliness in workspaces.

### Description of the Related Art

Painting and hand-mixing activities often require the use of various tools and materials, leading to challenges in organization and cleanliness. Traditional methods of mixing and storing paint brushes, paint cans, and mixing bowls are often messy and inefficient, resulting in wasted time and resources. Additionally, the rise in popularity of activities such as slime-making has created a need for specialized tools to facilitate these activities. Existing solutions lack versatility, often catering to either painting or slime-making, but not both. There is a clear need for a multifunctional tray that can efficiently handle both painting and hand-mixing tasks while maintaining cleanliness and organization.

According to industry research, the global paint and coatings market is expected to reach a value of $193.21 billion by 2026, driven by increasing construction activities and growing demand from various end-user industries. Similarly, the slime market has seen significant growth in recent years, with the trend gaining popularity among children and adults alike. However, despite the increasing demand for painting and slime-making materials, there remains a lack of efficient tools to streamline these activities. Existing solutions often fall short in terms of versatility, organization, and cleanliness, leading to frustration among users.

Several companies have introduced mixing trays and organizers for painting and crafting activities. These products typically focus on organizing paint brushes or storing paint cans but lack the versatility to accommodate both painting and slime-making needs. While some innovations include spill-proof designs or compartmentalized trays, they often fail to address the full range of requirements for painting and hand-mixing tasks. Additionally, few solutions offer waterproof features or dedicated compartments for slime ingredients, leaving users with limited options for managing these activities efficiently.

By looking at prior art multiple innovations can be seen. For instance, a U.S. Pat. No. 3,815,265A relates to color blending set and paint mixing tray. The color mixing tray which is a planar member with a plurality of wells arranged in an annular pattern. There are a plurality of wells in each of a plurality of sectors of the annular pattern, with wells in each sector radially spaced and each well in each sector having a counterpart in the other sectors. The counterpart wells of the sectors are in an annular ring within the annular pattern. Each well is separated from each other well by a wall and the walls between the wells within each sector are lower in height than the walls between the wells in adjacent sectors to facilitate transfer of paint between wells within a sector while maintaining isolation from sector to sector. A color mixing set combines the mixing tray with a supply of paints of mixing hues in balanced primary colors and in black and white, each paint supply being in a container having provision for dispensing measured quantities of paint therefrom. The set further includes a student guide having a spectrum chart representing the wells of the mixing tray together with indicia indicating the location of and providing instructions for mixing of the red, yellow and blue colors to create secondary and intermediate colors and for the mixing of the colors with each other and with the black and white paints to create shades, tints and tones.

A U.S. Pat. No. 5,735,399A relates to paint tray 10 having a main paint well (12) and pair of side paint wells (14, 16), with each paint well including a sloped floor with ribbing for applying paint to the sleeve of a paint roller, and further comprising a pair of clamps, one for each side paint well (14, 16) for securing the handle of a paint brush or paint roller. The main paint well includes a deep end (18), and side paint wells (14, 16) include deep well areas (48) that are each contiguous with the deep end (18) of the main paint well, to allow paint from the side paint wells to mix with paint in the main paint well.

A U.S. Pat. No. 6,761,287B2 relates to paint can lid with easy access for adding and viewing tint. The port assembly for a paint or similar can, in which a port in the lid is fitted with a threaded collar and a threaded stopper that fits into it. The port assembly allows easy access to the contents of the can while maintaining a good seal around the rim. If the threaded stopper is transparent and colorless, a user may view the contents of the can.

Existing solutions for organizing painting and hand-mixing activities require several improvements to meet the evolving needs of users. These improvements include the development of a multifunctional tray capable of accommodating both painting and slime-making tasks. The tray should feature a waterproof design to contain liquids without leakage, as well as dedicated compartments for holding paint brushes, paint cans, mixing bowls, and slime ingredients. Furthermore, the tray should be easy to clean and transport, with non-slip features to ensure stability during use.

The proposed invention, is the Mixing and Storage Tray for Paints and Hand-Mixed Products, addresses the shortcomings of existing solutions by providing a versatile and efficient solution for organizing painting and hand-mixing activities. This innovative tray features a durable and waterproof design, allowing it to contain liquids such as water, spilled paint, and slime materials without leakage. It includes dedicated compartments for holding paint brushes, gallon and quart paint cans, mixing bowls, and slime ingredients, catering to the needs of both painters and slime enthusiasts. Additionally, the tray features a removable insert for easy cleaning, a non-slip bottom surface, and a spill-proof lip for added convenience and stability.

The assembly fills the gap in the market by offering a comprehensive solution for managing painting and hand-mixing tasks in one versatile tray. Unlike existing solutions that cater to either painting or slime-making, our tray provides a multifunctional platform capable of accommodating both activities. Its waterproof design ensures cleanliness and prevents messes, while dedicated compartments ensure that materials are organized and easily accessible. By offering a single tool for various tasks, our invention streamlines workflows, saves time, and enhances the overall user experience for painters, artists, and hobbyists.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior mixing and storage plates and provide various design and functional advancements.

It is the objective of the invention to provide a versatile solution for painters and artists, allowing them to efficiently mix and store paintbrushes, gallon and quart paint cans, and a mixing bowl in one convenient tray.

It is a further objective of the present invention to offer a waterproof design, ensuring that the tray can hold liquids such as water for brush soaking, spilled paint, and slime materials without any leakage, thereby minimizing mess and cleanup time.

It is also an object of the invention to include compartments specifically designed for slime ingredients, enhancing the tray's functionality for users interested in both painting and slime-making activities.

It is further the objective of the invention to accommodate various brush sizes, providing differently sized compartments to securely hold brushes of different dimensions and prevent them from rolling or sliding during use.

It is also the objective of the invention to feature a removable tray insert, facilitating easy cleaning and maintenance of the tray to ensure hygienic and long-lasting use.

It is also the objective of the invention to incorporate a non-slip bottom surface and a spill-proof lip, preventing the tray from sliding or tipping over during use and containing liquids to prevent spills and accidents.

It is also the objective of invention to include a handle for easy transportation and handling, allowing users to carry the tray with ease from one location to another.

It is further the objective of the invention to provide a secure closure for compartments holding slime ingredients, ensuring that the ingredients remain fresh and contained until ready for use.

It is also the objective of the invention to transparent lid option, allowing users to easily identify stored materials without opening the compartments.

Thus, it is the objective to provide a new and improved form of assembly that enhances efficiency and cleanliness in workspaces by providing a practical and organized solution for managing painting and hand-mixing tasks, thereby improving productivity and user experience.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the complete view of the proposed assembly, as per an embodiment of the present disclosure.

FIG. 2 illustrates a bottom view of the present invention, per an embodiment of the present disclosure.

FIG. 3 illustrates the side view of the assembly per an embodiment of the present disclosure.

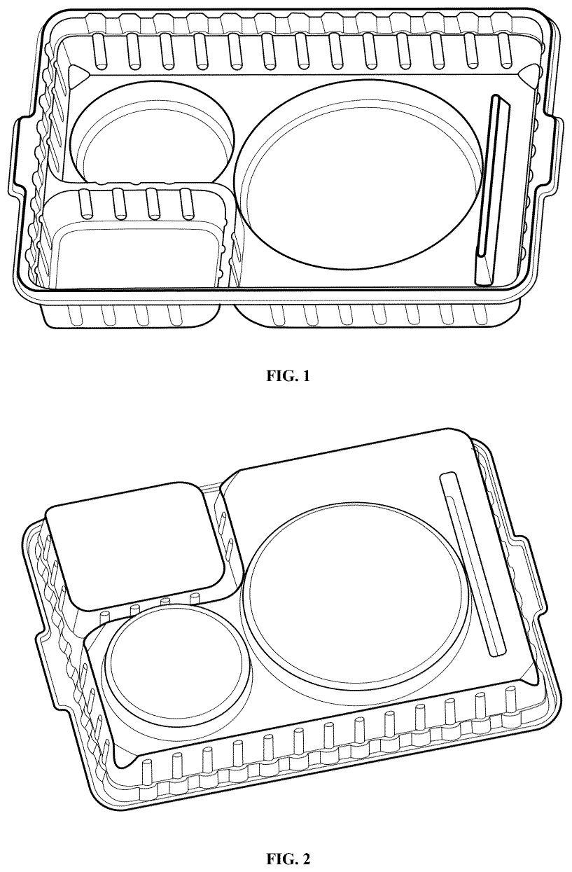

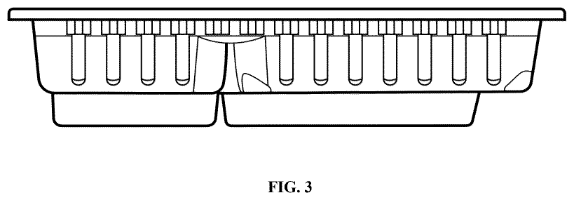

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The assembly as per its preferred embodiments is a mixing and storage tray for holding paintbrushes, gallon and quart paint cans, and a mixing bowl comprises a main body with multiple compartments. The main body is constructed from a durable and waterproof material, such as plastic or resin, ensuring the containment of liquids without leakage. The compartments are strategically designed to accommodate different items used in painting and mixing activities. One set of compartments is specifically sized and shaped to hold paintbrushes of various sizes securely, preventing them from rolling or sliding during use. Another set of compartments is configured to hold gallon and quart paint cans, with adjustable holders to accommodate different container sizes. Additionally, a larger compartment is incorporated into the design to hold a mixing bowl, allowing for the preparation of paint or other mixed substances.

As per its further embodiments, the mixing and storage tray features a waterproof design to prevent leakage of liquids, such as spilled paint or water used for brush soaking, from seeping through the tray. This waterproof feature is achieved through the use of sealing techniques or materials that provide a tight seal between the compartments and the main body of the tray. In one embodiment, the compartments are integrally molded with the main body, ensuring a seamless and watertight construction. Alternatively, sealing elements such as gaskets or rubber seals may be incorporated into the design to provide additional leak protection. This waterproof feature ensures that the tray can safely contain liquids without causing damage to surrounding surfaces or materials.

As per its further embodiments, in addition to holding paintbrushes and paint cans, the mixing and storage tray includes a compartment for holding slime ingredients. This compartment is designed to securely store various materials used in slime-making, including but not limited to glue, borax, and coloring agents. The compartment may feature dividers or partitions to organize different ingredients and prevent them from mixing prematurely. Furthermore, secure closures, such as snap-on lids or locking mechanisms, may be incorporated to ensure that the slime ingredients remain contained and fresh until ready for use. This dedicated compartment for slime ingredients enhances the versatility of the tray, catering to users interested in both painting and slime-making activities.

As per its further embodiments, the compartments for holding paintbrushes are specifically designed to accommodate brushes of various sizes. This is achieved through the incorporation of differently sized and shaped compartments within the main body of the tray. For instance, smaller compartments may be included for holding detail brushes, while larger compartments are provided for holding broader brushes used for covering larger areas. Additionally, the compartments may feature grooves or ridges along the bottom surface to securely hold the brush handles in place, preventing them from tipping over or sliding during use. This accommodation of various brush sizes ensures that users can easily access and organize their brushes according to their specific needs.

As per its further embodiments, the mixing and storage tray may further comprise a removable tray insert for easy cleaning and maintenance. The tray insert is designed to fit snugly within the main body of the tray and can be easily lifted out for cleaning or replacement. This removable feature allows users to thoroughly clean the tray, removing any paint residue or slime materials that may have accumulated during use. Additionally, the tray insert may be dishwasher-safe for added convenience. The removable tray insert enhances the longevity of the tray by facilitating regular cleaning, ensuring that it remains hygienic and ready for future use.

As per its further embodiments, to prevent the mixing and storage tray from sliding or tipping over during use, a non-slip bottom surface is incorporated into its design. This non-slip feature may consist of rubberized grips or textured patterns on the bottom surface of the tray, providing traction and stability on various surfaces. Furthermore, the tray may feature a spill-proof lip around the edges to contain liquids and prevent overflow. The spill-proof lip is designed to extend slightly above the rim of the tray, creating a barrier that prevents liquids from spilling over the sides. This combination of a non-slip bottom surface and a spill-proof lip ensures that the tray remains stable and secure during painting and mixing activities, minimizing the risk of accidents or spills.

As per its further embodiments, for ease of transportation and handling, the mixing and storage tray is equipped with a handle. The handle is ergonomically designed to provide a comfortable grip, allowing users to easily carry the tray from one location to another. It may be integrated into the main body of the tray or attached as a separate component. Additionally, the handle may feature reinforced construction to withstand the weight of the tray and its contents without bending or breaking. This handle provides added convenience for users, allowing them to transport the tray with ease, whether moving it around a workspace or taking it on-the-go for outdoor painting or crafting activities.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A mixing and storage tray comprising a main body with compartments for holding paintbrushes, gallon and quart paint cans, and a mixing bowl.

2. The mixing and storage tray of claim 1, further comprising a waterproof design to prevent leakage of liquids, including spilled paint and slime materials.

3. The mixing and storage tray of claim 1, wherein a compartment within the mixing and storage tray is for holding slime ingredients, including but not limited to glue, borax, and coloring agents.

4. The mixing and storage tray of claim 1, wherein the compartments for paintbrushes are designed to accommodate various brush sizes.

5. The mixing and storage tray of claim 1, wherein a removable tray insert within the mixing and storage tray allows for easy cleaning and maintenance. A

6. The mixing and storage tray of claim 1, further comprising a handle for easy transportation and handling.

7. The mixing and storage tray of claim 1, wherein a non-slip bottom surface on the mixing and storage tray prevents sliding during use.

8. The mixing and storage tray of claim 1, wherein a spill-proof lip around the edges of the mixing and storage tray contains liquids and prevents overflow.

9. The mixing and storage tray of claim 1, wherein the compartments for gallon and quart paint cans feature adjustable holders to accommodate different container sizes.

10. The mixing and storage tray of claim 1, wherein an integrated brush cleaner within the mixing and storage tray comprises ridges or bristles for removing excess paint from brushes.

11. The mixing and storage tray of claim 1, wherein a lid accessory for the mixing and storage tray covers and protects materials stored within the compartments.

12. The mixing and storage tray of claim 1, wherein the compartments for slime ingredients include secure closures to prevent spills and maintain freshness.

13. The mixing and storage tray of claim 1, wherein a transparent lid option for the mixing and storage tray allows stored materials to be identified without opening the compartments.

14. The mixing and storage tray of claim 1, further comprising measurement markings on the compartments for accurate mixing of paints and slime.

15. The mixing and storage tray of claim 1, wherein an ergonomic design of the mixing and storage tray provides comfortable handling and usage during painting and slime-making activities.

16. The mixing and storage tray of claim 1, wherein the tray is designed to securely hold the paint can lid during mixing, preventing any mess from the underside of the lid.
